(19) United States
(12) Patent Application Publication
(10) Pub. No.: US 2017/0182626 A1
(43) Pub. Date: Jun. 29, 2017

(54) Disc Nut Retaining Clip

(71) Applicant: Jack Stobie, Tha Dalles, OR (US)

(72) Inventor: Jack Stobie, Tha Dalles, OR (US)

(21) Appl. No.: 15/394,046

(22) Filed: Dec. 29, 2016

Related U.S. Application Data
(60) Provisional application No. 62/272,648, filed on Dec. 29, 2015.

(51) Int. Cl. B24B 23/02; F16B 2/22; F16B 1/00

(52) U.S. Cl. CPC B24B 23/028; F16B 1/00; F16B 2/22; F16B 2001/0035

(57) ABSTRACT

A disc nut retaining clip. The disc nut retaining clip is securable to an angle grinder and includes a body having a first end and a second end, the first end including a first curved portion and the second end including a second curved portion. An attachment member is connected to the first curved portion and includes apertures and corresponding fasteners for securing the retaining clip to a typical angle grinder. A retaining member is connected to the second curved portion, the retaining member including a lower surface having an arcuate shape. The retaining member is adapted to be received by a center portion of a disc nut in order to retain the disc nut against the outer side of the angle grinder.

### CROSS REFERENCE TO RELATED APPLICATIONS

This application claims the benefit of U.S. Provisional Application No. 62/272,648 filed on Dec. 29, 2015. The above identified patent application is herein incorporated by reference in its entirety to provide continuity of disclosure.

### FIELD OF THE INVENTION

The present invention relates to retainer clips. More specifically, the present invention provides a retaining clip attachable to an angle grinder for removably securing a disc nut thereto.

### BACKGROUND OF THE INVENTION

Angle grinders are utilized for various purposes, such as cutting, grinding, sanding, and polishing different materials and surfaces. Angle grinders allow for different tool attachments to be used depending on the task at hand, such as abrasive grinding discs, sanding discs, wire brush wheels, polishing pads, and more. Typically, the different tools are attached to the rotating end of the angle grinder via a disc nut, which is a circular nut having a central opening. In order to change the tool attachment, a user must also remove the disc nut. The disc nut can be lost easily, which renders the tool attachment unusable until the disc nut is found or replaced. Also, some tool attachments have their own integrated disc nut, and it is easy to misplace a disc nut for another tool attachment while utilizing a tool attachment with its own disc nut. It is therefore desirable to provide a retaining clip for securing a disc nut to an angle grinder while a user changes tool attachments or utilizes a tool attachment that has its own integrated disc nut.

Devices have been disclosed in the known art that relate to tool retaining clips. These include devices that have been patented and published in patent application publications. These devices generally relate to retaining clips, such as U.S. Published Patent Application Number 2006/0104735, U.S. Pat. No. 6,688,407, U.S. Published Patent Application Number 2005/0133552, U.S. Published Patent Application 2006/0091168, U.S. Pat. No. 4,065,886, and U.S. Pat. No. 8,066,268.

The devices in the known art have several drawbacks. The devices in the known art provide general clips for accessories and for clipping a tool to a belt, but fail to provide clips that secure specific components against the outer edge of the tool itself. The devices in the known art further fail to provide a retaining clip that is removably securable to an angle grinder and is specifically shaped and sized to secure a disc nut to the outer side of an angle grinder.

In light of the devices disclosed in the known art, it is submitted that the present invention substantially diverges in design elements from the prior art and consequently it is clear that there is a need in the art for an improvement to existing disc nut retaining devices. In this regard the present invention substantially fulfills these needs.

### SUMMARY OF THE INVENTION

In view of the foregoing disadvantages inherent in the known types of retaining clips now present in the prior art, the present invention provides a disc nut retaining clip wherein the same can be utilized for providing convenience for the user when securing a disc nut to the outer side of an angle grinder. The disc nut retaining clip includes a body having a first end and a second end, where the first end includes a first curved portion and the second end includes a second curved portion. An attachment member that is substantially planar s connected to the first curved portion. A plurality of fasteners are included for securing the attachment member to an outer side of an angle grinder, wherein the plurality of fasteners are insertable through the plurality of apertures. A retaining member including a lower surface having an arcuate shape is connected to the second curved portion. The retaining member is adapted to be received by a center portion of a disc nut, and the retaining member is further adapted to retain the disc nut against the outer side of the angle grinder.

One object of the present invention is to provide a disc nut retaining clip that is securable to the side of any standard angle grinder.

Another object of the present invention is to provide a new and improved disc nut retaining clip that has none of the disadvantages of retaining clips in the known art.

A further object of the present invention is to provide a disc nut retainer dip having a magnet for more effectively securing the disc nut to the outer side of an angle grinder.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a disc nut retaining clip according to the present invention.

FIG. 2 shows a perspective view of a disc nut retaining clip according to the present invention in use.

### DETAILED DESCRIPTION OF THE INVENTION

Reference is made herein to the attached drawings. Like reference numerals are used throughout the drawings to depict like or similar elements of the disc nut retaining clip. For the purposes of presenting a brief and clear description of the present invention, the preferred embodiment will be discussed as used for securing a disc nut to an outer side of an angle grinder. The figures are intended for representative purposes only and should not be considered to be limiting in any respect.

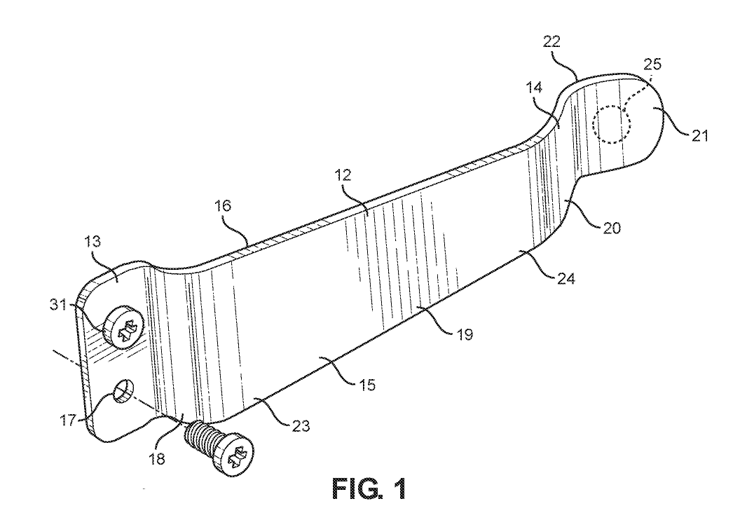

Referring now to FIG. 1, there is shown a perspective view of a disc nut retaining clip according to the present invention. The disc nut retaining clip generally comprises a body 12 having a first end 14 and an opposing second end 16. The first end 14 has a width 23 that is greater than a width 24 of the second end 16. The body 12 is preferably composed of a durable, rustproof metal such as aluminum or stainless steel. The body 12 may be unitary in structure and may be formed via a press, stamping, or any other suitable method for forming a unitary component.

The first end of 14 of the body 12 comprises a first curved portion 18. An attachment member 13 is connected to the first curved portion 18. The attachment member 13 is substantially planar so that it may rest flush against a planar surface of an angle grinder housing. A plurality of apertures 17 are disposed on the attachment member 13. Each aperture 17 is configured to receive a fastener 31, which is shown as a screw in the illustrated embodiment. In alternate embodiments, the fastener 31 may be a rivet or other suitable type of fastener. In the illustrated embodiment, there are two apertures 17 disposed adjacent to one another in order to effectively secure the body 12 of the disc nut retaining clip to an angle grinder. However, additional apertures 17 may be utilized. Additionally, the attachment member 13 may be removably securable to the angle grinder if screws or similar fasteners 31 are utilized.

The second end 16 of the body 12 comprises a second curved portion 20. A retaining member 21 extends from the second curved portion 20. The retaining member 21 comprises a lower surface 22 that contacts a disc nut when in use. In the illustrated embodiment, the lower surface 22 further comprises a magnet 25 thereon. The magnet 25 attracts the metal disc nut and provides additional means of securement. In alternate embodiments, a magnet 25 is not included and the disc nut is secured to the angle grinder solely via pressure exerted by the retaining member 21.

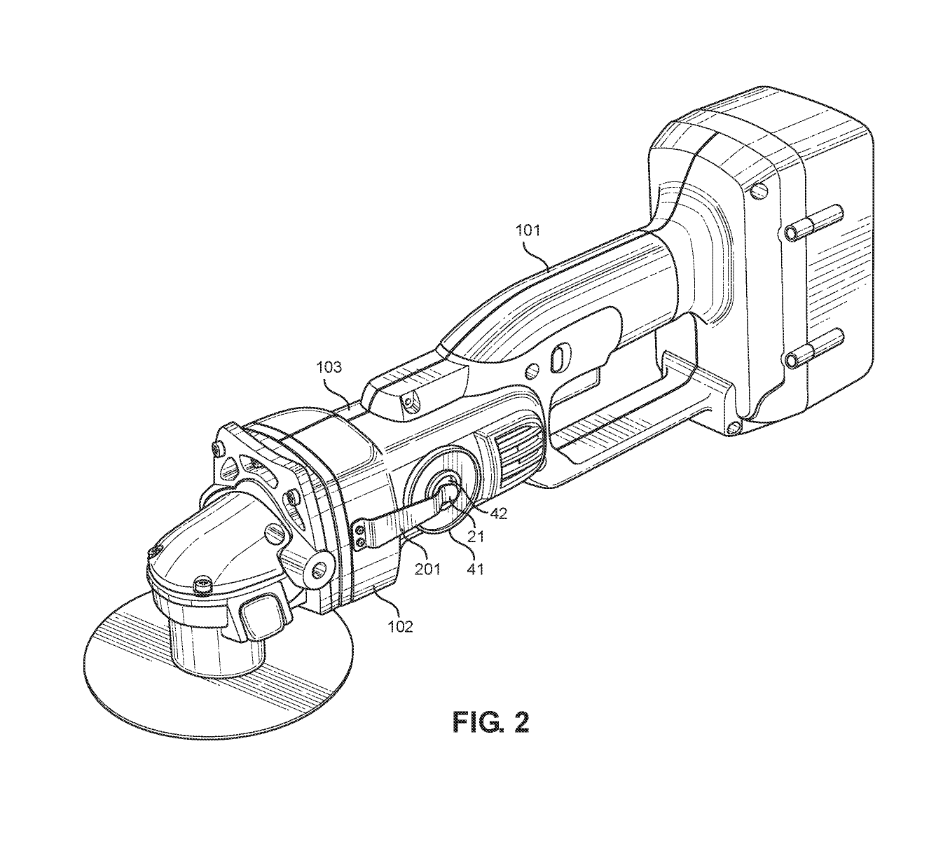

Referring now to FIG. 2, there is shown a perspective view of a disc nut retaining clip according to the present invention in use. The angle grinder 101 generally comprises a housing 103 that includes an outer side 102 positioned toward the rotating member. The retaining clip 201 is secured to the outer side 102 of the angle grinder. The retaining clip 201 may be integrally formed with the angle grinder housing 103 or may be secured to the housing 103 by drilling holes for the attachment member to be secured thereto via the plurality of fasteners.

The retaining member 21 of the retaining clip 201 is biased towards the outer side 102 of the angle grinder 101. When a disc nut 42 is placed between the retaining member 21 and the outer side 102 of the angle grinder 101, a lower surface of the retaining member 21 engages the edges of the open center portion 42 of the disc nut 41. Further, the retaining clip 201 is configured to bend away from the outer side 102, causing the retaining member 21 to exert a force against the disc nut 41, securing it in place against the angle grinder 101. In order to remove the disc nut 41, the user may simply bend the retaining member 21 backward toward the first end of the retaining clip 201, which causes the disc nut 41 to be released.

In use, a user may secure the disc nut retaining clip to any angle grinder. Alternatively, the clip may be integrally formed to the outer surface of the angle. It is contemplated that the retaining clip may be sold commercially in a kit that includes the plurality of fasteners, a drill bit for drilling apertures into the outer side of an existing angle grinder, and an instruction manual. The instruction manual includes detailed images and directions for instructing users how to secure the attachment member of the retaining clip to the angle grinder, and how to use the retaining clip to retain a disc nut. The exact specifications and dimensions of the disc nut retaining clip may vary upon manufacturing.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A retaining clip, comprising:
a body comprising a first end and a second end, the first end comprising a first curved portion and the second end comprising a second curved portion;
an attachment member connected to the first curved portion, the attachment member being substantially planar;
a plurality of apertures disposed on the attachment member;
a plurality of fasteners insertable through the plurality of apertures for securing the attachment member to an outer side of an angle grinder;
a retaining member connected to the second curved portion, the retaining member comprising a lower surface having an arcuate shape, the retaining member adapted to be received by a center portion of a disc nut; and
wherein the retaining member is adapted to retain the disc nut against the outer side of the angle grinder.

2) The retaining clip of claim 1, wherein the plurality of apertures comprises two apertures.

3) The retaining clip of claim 1, wherein the plurality of fasteners comprises a screw.

4) The retaining clip of claim 1, wherein the plurality of fasteners comprises a rivet.

5) The retaining clip of claim 1, wherein the attachment member is removably secured to the angle grinder.

6) The retaining clip of claim 1, wherein the first end of the body comprises a width that is less than a width of the second end of the body.

7) The retaining clip of claim 1, further comprising a magnet disposed on the lower surface of the retaining member.
